(19) United States
(12) Patent Application Publication
(10) Pub. No.: US 2006/0182296 A1
(43) Pub. Date: Aug. 17, 2006

(54) Ultrasonic ear wax cleaning system

(76) Inventor: Natan Bauman, Cheshire, CT (US)

Correspondence Address: BACHMAN & LAPOINTE, P.C., 900 CHAPEL STREET, SUITE 1201, NEW HAVEN, CT, 06510, US

(21) Appl. No.: 11/056,964

(22) Filed: Feb. 11, 2005

(51) Int. Cl. H04R 25/00

(52) U.S. Cl. 381/325

(57) ABSTRACT

A system for removing ear wax from an ear canal is provided. The system includes a device for creating ultrasound waves at a frequency sufficient to dislodge ear wax in the ear canal and to break up the ear wax into small particles. The system further includes a device for removing the dislodged ear wax from the ear canal via suction.

### BACKGROUND OF THE INVENTION

(1) Field of the Invention

The present invention relates to a system and a method for removing ear wax from a patient's ear canal.

(2) Prior Art

Ear wax, or cerumen, buildup in the ear canal can adversely affect one's hearing. Thus, it often becomes necessary for a physician or an audiologist to periodically remove ear wax from the ear canal. A variety of devices have been proposed in the prior art to accomplish this result.

U.S. Pat. No. 4,411,265 to Eichenlaub illustrates one type of ear wax removal device. The device has a hollow curette connected to a source of circulating warm fluid and movably mounted in forwardly and gently biased relation for longitudinal movement upon a mounting plate which is designed to rest against the side of the patient's head and carries an adjustable abutment which limits the depth of insertion of the curette into the patient's ear.

U.S. Pat. No. 6,155,987 to Scherl illustrates another ear wax removal assembly. The assembly includes a funnel shaped speculum that is inserted into a patient's ear canal and an ear wax repository which is articulated to the speculum. The repository can take the form of a cavity, a sheet, or a suction mechanism. The position of the speculum governs the position of the repository and both are controlled by a physician during the ear wax removal procedure.

It is also known in the art to use ultrasonic technology to clean hearing aids. For example, in U.S. Pat. No. 4,987,597 to Haertl, an apparatus for closing an opening of a hearing aid or an ear adaptor for a hearing aid is described. The patent talks about removing a build up of cerumen from the cap of a hearing aid or ear adaptor by partially immersing the hearing aid or the ear adaptor into an ultrasound bath.

U.S. Pat. No. 4,920,954 to Alliger et al. illustrates an ultrasonic device for removing plaque from a human artery.

Despite the existence of ear wax removal devices, there remains a need for a more efficient and more effective system for removing ear wax.

### SUMMARY OF THE INVENTION

It is an object of the present invention to provide a system for removing ear wax from an ear canal.

It is a further object of the present invention to provide a method for removing ear wax from an ear canal.

The foregoing object(s) are attained by the ear wax cleaning system of the present invention.

In accordance with the present invention, a system for removing ear wax from an ear canal is provided. The system broadly comprises means for creating ultrasound waves to dislodge ear wax in the ear canal and to break the ear wax up into small particles and means for removing the dislodged ear wax particles from the ear canal.

Further in accordance with the present invention, a method for removing ear wax from an ear canal is provided. The method broadly comprises the steps of generating ultrasound waves to dislodge ear wax in the ear canal and to break up the ear wax into small particles and removing the dislodged ear wax particles from the ear canal.

Other details of an ultrasonic ear wax cleaning system in accordance with the present invention, as well as other objects and advantages attendant thereto, are set forth in the following detailed description and the accompanying drawings wherein like reference numerals depict like elements.

### BRIEF DESCRIPTION OF THE DRAWINGS

FIG. 1 illustrates a first embodiment of an ultrasonic ear wax cleaning system in accordance with the present invention;

FIG. 2 illustrates a second embodiment of an ultrasonic ear wax cleaning system in accordance with the present invention; and

FIG. 3 illustrates the mobility of an ear wax cleaning system in accordance with the present invention to remove ear wax as needed.

### DETAILED DESCRIPTION OF THE PREFERRED EMBODIMENT(S)

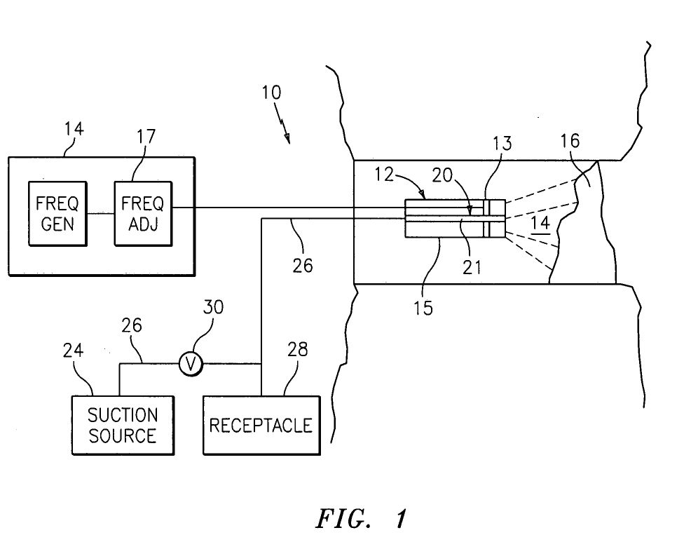

Referring now to FIG. 1, a system 10 for removing unwanted ear wax 16 from an ear canal of a person or other animal is illustrated. The system 10 includes a probe 12 which can be inserted at least partially into the ear canal 14. The probe 12 contains an ultrasonic transducer 13 within its housing 15. The ultrasonic transducer 13 is connected to a device 14 for generating a desired level of ultrasonic wave frequencies and intensities. The connection between the ultrasonic transducer 13 and the device 14 may comprise any suitable means known in the art for transmitting an ultrasonic frequency signal to the transducer 13. The frequency generator device 14 may comprise any suitable frequency generator known in the art. Preferably, the frequency generator device 14 has means 17 for adjusting the ultrasonic frequency signal which is produced and its intensity to a suitable level for dislodging and/or breaking up the ear wax 16 into small particles. The adjusting means 17 may comprise any suitable means known in the art.

To dislodge or break up the ear wax 16 into small particles, the probe 12 is inserted either partially or fully into the ear canal 14. The probe 12 preferably is spaced a suitable distance from the ear wax 16. The device 14 is then operated to generate an ultrasonic frequency signal which is received by the transducer 13 and converted into ultrasonic waves which cause the ear wax 16 to dislodge from the ear canal 14 and break up into smaller pieces.

In a preferred embodiment, the probe 12 further includes a means 20 for removing the dislodged ear wax particles from the ear canal 14. The removing means 20 may comprise any suitable removal means known in the art. In a preferred embodiment, the removal means 20 comprises a passageway 21 within the probe 12, which passageway 21 may be connected to a suction source 24 via a tube 26. The suction source 24 may be any suitable suction source known in the art. Preferably, the suction source is an air suction source. The tube 26 is also connected to a receptacle 28 for receiving the dislodged ear wax 16.

While FIG. 1 shows the removing means 20 to be centrally located within the probe 12, it should be understood that the removing means could be positioned elsewhere within the probe 12.

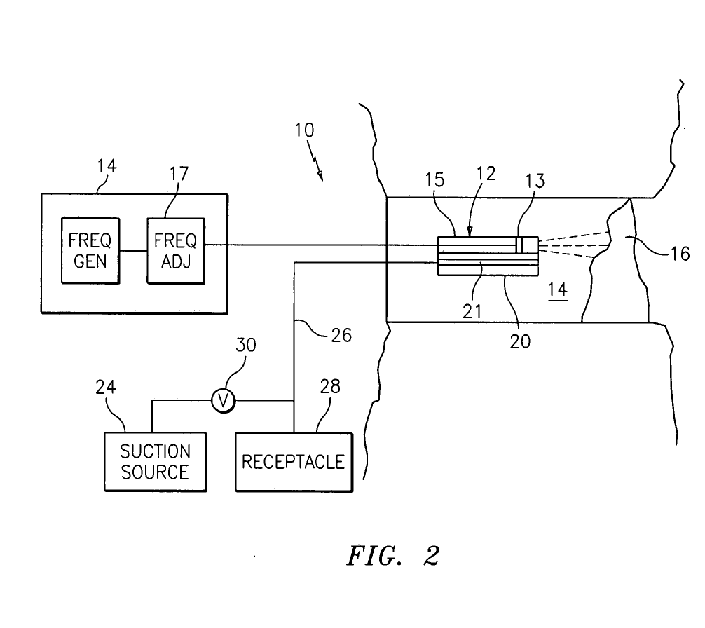

While FIG. 1 shows the removing means 20 to be located within the probe 12, the removing means 20 could be located externally of the probe 12 as shown in FIG. 2.

In operation, the ear wax 16 is dislodged and broken up into small particles by the application of ultrasonic waves to the ear wax. The dislodged and broken ear wax particles may then be removed by the removal means 20 and gathered in receptacle 28.

If desired, the suction source may have means 30 for adjusting the degree of suction which is applied. The adjusting means may comprise any suitable means known in the art. For example, the adjusting means 30 may comprise a valve positioned within tube 26.

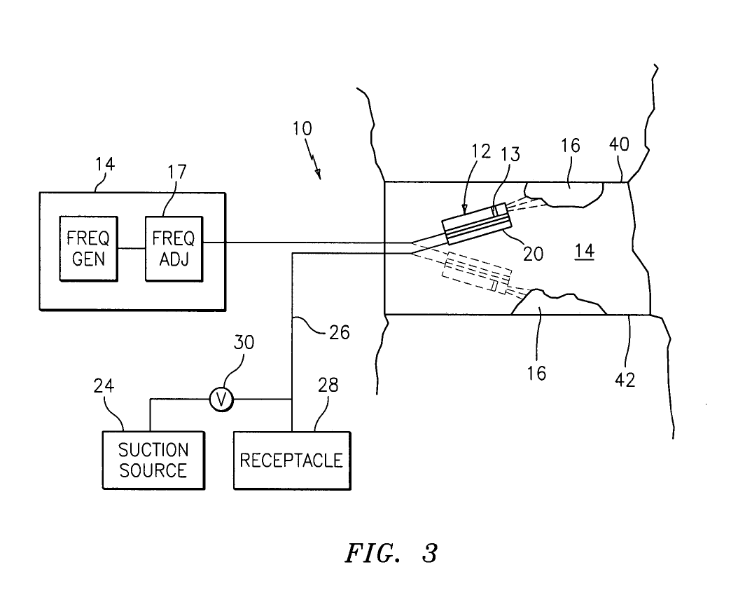

FIG. 3 illustrates the mobility of the ear wax cleaning system 10 of the present invention. The ear wax 16 may be located on more than one surface of the ear canal 14. The probe 12 may be sufficiently small so that the probe and the ultrasonic waves can be aimed at the ear wax deposit on the first wall 40 to dislodge and break up same and then repositioned to a second position so that the ear wax deposit on a second wall 42 can be dislodged and broken up into small particles.

As can be seen from the foregoing description, an ear wax cleaning system 10 is provided which is simple in construction and easy to use. It allows ear wax to be removed from an ear canal without causing any pain or discomfort. Further, the cleaning system 10 can be compact and easily transportable, allowing it to be used in any environment.

It is apparent that there has been provided in accordance with the present invention an ultrasonic ear wax cleaning system which fully satisfies the objects, means, and advantages set forth hereinbefore. While the present invention has been described in the context of specific embodiments thereof, other alternatives, modifications, and variations will become apparent to those skilled in the art having read the foregoing description. Accordingly, it is intended to embrace those alternatives, modifications, and variations as fall within the broad scope of the appended claims.

What is claimed is:

1. A system for removing ear wax from an ear canal, said system comprising:
means for creating ultrasound waves at a frequency and an intensity sufficient to dislodge ear wax in said ear canal and to break up the ear wax into small particles; and
means for removing said dislodged ear wax from said ear canal.

2. The system according to claim 1, wherein said means for creating ultrasound waves comprises a probe sized to be insertable within said ear canal.

3. The system according to claim 2, wherein said probe contains an ultrasonic transducer and said transducer is connected to an ultrasonic frequency generator.

4. The system according to claim 3, wherein said ultrasonic frequency generator has means for adjusting the ultrasonic frequencies and intensities which are generated.

5. The system according to claim 2, wherein said removing means comprises a passageway within the probe to which a suction force is applied.

6. The system according to claim 5, wherein said passageway is located centrally within the probe.

7. The system according to claim 5, further comprising means for adjusting said suction force.

8. The system according to claim 5, wherein said receptacle is connected to a receptacle.

9. The system according to claim 2, wherein said removing means comprises means for applying a suction force and said suction force applying means is positioned externally of said probe.

10. A method for removing ear wax from an ear canal, said method comprising the steps of:
generating ultrasound waves within the ear canal to dislodge ear wax in the ear canal and to break up the ear wax into small particles; and
removing the dislodged ear wax particles from the ear canal.

11. A method according to claim 10, wherein said ultrasound wave generating step comprises inserting a probe containing an ultrasonic transducer at least partially into the ear canal and transmitting an ultrasonic frequency signal to said transducer.

12. A method according to claim 11, wherein said removing step comprises providing a passageway and applying a suction force to said passageway so as to remove said dislodged ear wax from said ear canal.

13. A method according to claim 12, wherein said passageway providing step comprises providing said passageway within said probe.

14. A method according to claim 12, wherein said passageway providing step comprises providing said passageway externally of said probe.
